(19) United States
(12) Patent Application Publication
(10) Pub. No.: US 2017/0361781 A1
(43) Pub. Date: Dec. 21, 2017

(54) PROCESS FOR MANUFACTURING A MOTOR VEHICLE PART

(71) Applicant: Compagnie Plastic Omnium, Lyon (FR)

(72) Inventors: Issam KHAYAT, Lyon (FR); Jean-Francois PRAT, Villeurbanne (FR); David TRESSE, Saint-Andre de Corcy (FR); Arnaud ESCOFFIER, Lyon (FR)

(73) Assignee: Compagnie Plastic Omnium, Lyon (FR)

(21) Appl. No.: 15/532,779

(22) PCT Filed: Dec. 7, 2015
(86) PCT No.: PCT/FR2015/053347

§ 371 Date: Jun. 2, 2017

(30) Foreign Application Priority Data
Dec. 5, 2014 (FR) 1461961

(51) Int. Cl. B60R 13/01; B60R 13/02

(52) U.S. Cl. CPC B60R 13/01; B60R 13/0243

(57) ABSTRACT

A process for manufacturing a motor vehicle part, wherein the part is produced by molding a filled thermoplastic material, the part thus molded is subsequently reinforced by positioning locally and at the surface of the part at least one reinforcing element including strips of unidirectional continuous fibers, the strips being deposited non-continuously on the part in at least one stress concentration zone.

### FIELD OF THE INVENTION

This invention relates to a process for manufacturing a semi-structural motor vehicle part, such as a tailgate inner liner, made of reinforced thermoplastic material.

### BACKGROUND OF THE INVENTION

A semi-structural motor vehicle part designates a part enabling the assembly incorporating this part to be self-supporting, and guaranteeing a geometry under a given load, with no visible deformation.

A tailgate made of thermoplastic material comprising an appearance outer skin and an inner structural liner made of filled thermoplastic material is known, in the state of the art. The thermoplastic material forming the liner is for example filled with glass fibers or talc to increase its strength properties.

These products are subject to numerous limiting conditions creating stress and strain levels in different directions of the material and concentrated on certain zones. Unless these zones, known as weakness zones, are reinforced, the product stiffness and geometry would not be guaranteed and the specifications would not be met.

The inner liner is therefore reinforced by insert type reinforcing elements (metal or composite), overmolded onto the liner or added after molding the liner, to improve their mechanical properties at the most stressed points (hinges, ball joints, lock, etc.). These inserts are for example screwed, clipped or riveted.

This process for manufacturing a liner is long and complex due to the large number of operations to be implemented after molding the filled plastic material.

Furthermore, the design of overmolded or added inserts (metal or composite) must take into account the metalworking, stamping, or shaping rules that often impose geometries that are not optimized for the design and lightness.

This therefore results in the need to add material not necessary for the reinforcements since it does not play a role in the reinforcement. For this reason also, these metal or composite reinforcements may reach a weight that is non-negligible at the scale of the part they are intended to reinforce.

In addition, the process for overmolding this insert places considerable restrictions on the design of the part. This may generate stiffness in the sheet metal or composite insert which is not optimum to overcome these problems related to the overmolding process. In addition, it is known, for example from document FR2908067A1, to replace these metal inserts by reinforcements made of thermosetting material with reinforcing fibers (prepreg). Such reinforcements are typically available as consolidated plates which can be shaped using suitable processes (stamping, draping, thermoforming, etc.) before overmolding. Generally, these reinforcements are overmolded by thermoplastic material.

However, mechanical keys such as holes are required to make the thermosetting materials adhere to the parts to be reinforced. Moreover, the geometries required cannot always be produced using these processes and impose a considerable number of feasibility iterations. Compromises must therefore be made regarding the different objectives: weight, performance, cost of materials and processes.

### OBJECT AND SUMMARY OF THE INVENTION

The invention aims to provide a process for manufacturing a semi-structural motor vehicle part, such as an opening (tailgate, side door, bonnet) or an opening liner, reinforced by at least one reinforcing element which does not have the drawbacks of the known processes.

The invention therefore relates to a process for manufacturing a motor vehicle part, wherein said part is produced by molding filled thermoplastic material, and said part is reinforced by positioning locally at least one reinforcing element, wherein the reinforcing element comprises tapes of unidirectional continuous fibers and in that the tapes are deposited non-continuously on said part in at least one stress concentration zone.

The process avoids material losses since the fact that the tapes are deposited discontinuously avoids material offcuts and only the material required is used where reinforcements are needed.

The process increases the weight of the part, since the discrete arrangement of the tapes only in the highly stressed zones results in minimum consumption of reinforcing materials.

Lastly, unlike the process based on sheet metal inserts, the process according to the invention does not require a pre and post molding operator, therefore increasing productivity.

Advantageously, the tapes can be deposited by orienting the continuous fibers in preferred directions corresponding to the main stresses in the stress concentration zone.

According to the invention, several tapes can be deposited on top of each other, so as to manage the thickness of the tapes without making the tapes deposited less flexible.

Preferably, tapes of width less than 1.3 centimeters are used.

According to a preferred embodiment, tapes with thermoplastic resin are used.

Alternatively, tapes without thermoplastic resin can be deposited simultaneously with a heated thermoplastic resin.

According to the invention, a thermoplastic resin is used whose melting point is substantially identical to that of the thermoplastic material of the part.

Advantageously, the thermoplastic resin is heated and/or said zone of the part is heated during the step of depositing said tapes, to help the tapes adhere to the part.

The thermoplastic material may be polypropylene-based filled with short glass fibers, and the thermoplastic resin may also be polypropylene-based.

Preferably, a thermoplastic material filled with reinforcing fibers and/or talc is used.

Reinforcing fibers can be used alone or in combination, selected from the following fibers: glass fiber, carbon fiber, natural fiber.

According to one embodiment, the part is a semi-structural part, such as an opening or an opening liner. If the part is a tailgate inner liner, the stress concentration zone can be selected from any of the elements of the assembly formed by an upper region of the tailgate for attaching a hinge, a side region of the tailgate taking up the forces of the struts, and a lower side region of the tailgate for attaching a lock.

The part may also be a side door or bonnet liner.

According to a particular embodiment, prior to the step of molding said part in a mold, at least one reinforcing element having tapes of unidirectional continuous fibers is deposited locally on the walls of the mold, the tapes being deposited non-continuously on the mold in at least one zone, corresponding to a stress concentration zone of the future part molded in said mold, and the step of depositing tapes on the surface of said part is optional.

According to another particular embodiment, prior to the step of molding said part in a mold, at least one reinforcing element having tapes of unidirectional continuous fibers is deposited locally on the walls of a preform, the tapes being deposited non-continuously on the preform in at least one zone, corresponding to a stress concentration zone of the future part molded in said mold, then the preform so obtained is positioned in the mold, and the step of depositing tapes on the surface of said part is optional.

The invention also relates to a motor vehicle part, produced by molding filled thermoplastic material and comprising at least one reinforcing element in at least one stress concentration zone. The reinforcing element is a set of discontinuous tapes of unidirectional continuous fibers impregnated with thermoplastic resin deposited on the surface of said part.

The fibers of the tapes can be oriented according to preferred directions corresponding to main stresses in the stress concentration zone.

Lastly, the part can be a semi-structural part, such as an opening or an opening liner.

### BRIEF DESCRIPTION OF THE DRAWINGS

The invention will be better understood on reading the following description, referring only to the accompanying figures in which:

FIG. 1 illustrates a tape of unidirectional continuous fibers used in the process according to the invention.

FIG. 2 illustrates a perspective view of a tailgate obtained by the process according to the invention, and indicating the zones of high stresses on which tapes have been arranged.

### MORE DETAILED DESCRIPTION

The invention relates to a process for manufacturing a motor vehicle part (1), such as a semi-structural part, reinforced by at least one reinforcing element. The process comprises the following steps:
firstly, manufacturing the part using a process for molding filled thermoplastic material;
secondly, reinforcing this part (1) thus molded, by positioning locally and on the surface of the part (1) at least one reinforcing element comprising tapes (2) of unidirectional continuous fibers (3). These tapes (2) are deposited non-continuously on the part (1) already molded in at least one stress concentration zone (4).

A stress concentration zone (4) means a zone of high stresses. Such a zone therefore includes main stresses, corresponding to directions along which the zone is subject to the highest stress.

For example (FIG. 2), if the part is a tailgate liner, the stress concentration zone can be selected from any of the elements of the assembly formed by an upper region of the tailgate for attaching a hinge (4a), a side region of the tailgate taking up the forces of the struts (4b), and a lower side region of the tailgate for attaching the lock (4c).

Preferably, the tapes (2) are deposited so as to orient the continuous fibers (3) they contain according to preferred directions, corresponding to the main stresses experienced in the zone.

The part (1) is produced by molding filled thermoplastic material (MTP), for example using an injection molding process.

A filled thermoplastic material (MTP) means a thermoplastic material containing mineral fillers, such as talc, and/or containing reinforcing fibers. The reinforcing fibers are selected alone or in combination, from the following fibers: glass fiber, carbon fiber, natural fiber (such as flax for example).

Advantageously, the part is a semi-structural part such as a motor vehicle opening, for example a tailgate, a side door or a bonnet. It may also be a liner for such an opening (inner liner of a tailgate, side door or bonnet). The following description refers to the example of a tailgate inner liner, as shown on FIG. 2.

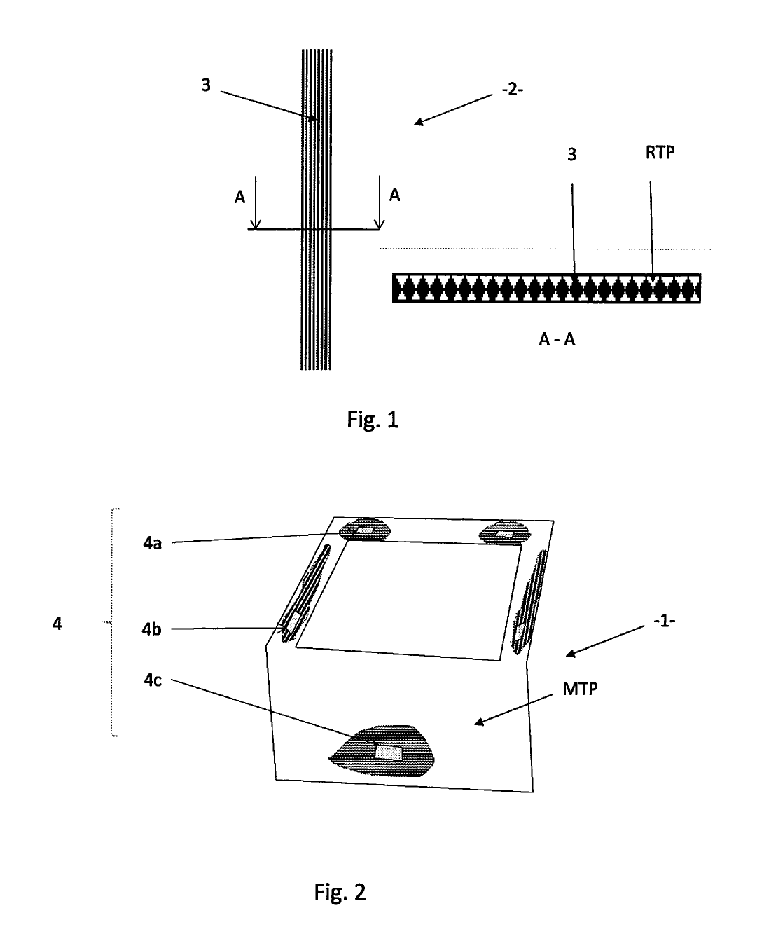

A tape is a set of continuous fibers (3) oriented in the same direction (FIG. 1). The reinforcing fibers are selected alone or in combination, from the following fibers: glass fiber, carbon fiber, natural fiber (such as flax for example).

A tape (3) is defined by its format whose width is small compared to the length. Advantageously, for draping motor vehicle parts, tapes of width less than 1.3 cm, preferably less than 1.27 cm, are used. FIG. 1 illustrates a tape (2) seen from above, and a cross-section (AA) to illustrate the thickness of the tape (2) and the arrangement of the fibers (3).

Sufficiently thin tapes (2) are used to retain sufficient flexibility in order to allow draping on any shape. If necessary, tapes can be draped on top of each other to further reinforce the zone to be reinforced.

According to a preferred embodiment, the tapes (2) comprise thermoplastic resin (RTP), in which the fibers (3) are embedded (FIG. 1).

According to this embodiment, and advantageously, the thermoplastic resin (RTP) is heated before applying it against the part (1). This fluidifies the tape (2) and makes it easier to deposit on all shapes of the part (1), thus favoring the draping of this tape (2).

Preferably, the zone (4) of the part on which the tape (2) is to be deposited is also, or alternatively, heated. The resin (RTP) of the tape and the thermoplastic material (MTP) of the part therefore melt, thus helping to keep the tape (2) on the part (1) since the resin (RTP) and the thermoplastic material (MTP) mix together, and by compatibility and then cooling, form a single structure. In this case, tapes (2) whose resin (RTP) has a melting point substantially identical to that of the thermoplastic material (MTP) of the part are preferably used.

For example, a polypropylene-based thermoplastic material (MTP) filled with short glass fibers can be used to form the part (1), and thermoplastic resin (RTP), also polypropylene-based, can be used to form the tapes (2).

Depending on the need for reinforcing the zone (4), in other words depending on the stress experienced by the zone (4), tapes (2) of variable width and thickness are deposited.

Thus, the greater the need, the thicker the tape used will be. Furthermore, according to the process, several tapes (2) can be deposited on top of each other, to increase the thickness of the reinforcement formed by these tapes (2), and thus increase the reinforcement in the selected zone (4).

According to one embodiment, dry tapes (2), i.e. without thermoplastic resin, are deposited on the zone (4) at the same time as a heated thermoplastic resin (RTP) is deposited. The thermoplastic resin (RTP) used can be the same as that used for the tapes impregnated with thermoplastic resin.

The tapes (2) are deposited automatically using a tool, in order to drape the tapes on the shapes of the part (1).

The tool is an automated system, for example a robot, having an arm provided with a tape (2) applicator, for example cylindrical, comprising a shape adapted to drape the tape (2) on the zone (4) of the part to be reinforced, and which can move over it. The tape (2) can be unwound continuously and cut to the required length.

The tool also has a roller, to apply pressure so as to sandwich the tape (2) between the applicator and the wall of the part (1). According to one embodiment, the applicator itself applies the necessary pressure.

The tool also has a means for cutting the tape (2), such as blades, in order to deposit pieces of tape (2) and not a continuous tape.

Lastly, the tool preferably has a means for heating the tape (2) when the latter comprises resin (RTP). This means fluidifies the tape (2), and spreads it on the part (1) using the applicator and the roller. This means can be integrated directly in the applicator.

Preferably this means can also, or alternatively, heat the zone (4) of the part to be reinforced.

The process is automated and the tool moves along a predefined path, to arrange one or more thicknesses of tape (2) in one zone (4) and then continue, after cutting, by arranging tapes in another zone (4) to be reinforced. The process for depositing tape is therefore discontinuous, since the tool does not deposit a tape continuously, but instead deposits pieces of tape (2) at different positions on the part (1).

This type of tool can drape the tape (2) in situ on complex shapes of the part (1), while reducing human intervention, thereby improving productivity. Reinforced parts can be produced in large quantities with reduced cycle time.

The invention also relates to a motor vehicle part (1) manufactured by the process according to the invention. Thus, the invention relates to a part (1) produced by molding filled thermoplastic material and comprising at least one reinforcing element. The reinforcing element is a set of discontinuous tapes (2) of unidirectional continuous fibers (3) impregnated with thermoplastic resin (RTP), deposited on the surface of the part (1).

Preferably, the fibers (3) of the tapes are oriented according to preferred directions corresponding to the main stresses in the stress concentration zone.

According to exemplary embodiments, the part (1) is a semi-structural part such as a motor vehicle opening, for example a tailgate, a side door or a bonnet. It may also be a liner for such an opening (inner liner of a tailgate, side door or bonnet).

According to a first alternative embodiment, the tapes (2) are deposited directly in the mold in which the part (1) will be molded, the mold is then closed and the thermoplastic material (MTP) used to manufacture the part (1) is injected. Thus, the process for manufacturing a motor vehicle part (1) comprises the following steps:
depositing locally on the walls of a mold at least one reinforcing element comprising tapes (2) of unidirectional continuous fibers (3), the tapes (2) being deposited non-continuously on the mold in at least one zone corresponding to a stress concentration zone (4) of the future part (1) molded in said mold;
closing the mold, then injecting a filled thermoplastic material (MTP), in order to manufacture the part (1).

The step of depositing tapes (2) on the surface of the molded part (1) being optional in this case.

According to a second alternative embodiment, the tapes (2) are deposited on a preform so as to obtain at least one preformed reinforcement. Thus, the process for manufacturing a motor vehicle part (1) comprises the following steps:
depositing locally on the walls of a preform at least one reinforcing element comprising tapes (2) of unidirectional continuous fibers (3), the tapes (2) being deposited non-continuously on the preform in at least one zone corresponding to a stress concentration zone (4) of the future part (1) molded in said mold;
positioning the preform(s) thus obtained in a mold;
closing the mold, then injecting a filled thermoplastic material (MTP), in order to manufacture the part (1).

The step of depositing tapes (2) on the surface of the molded part being optional in this case.

1. A process for manufacturing a motor vehicle part, the process comprising:
producing the motor vehicle part by molding a filled thermoplastic material,
reinforcing the motor vehicle part by positioning locally and at a surface of said motor vehicle part at least one reinforcing element including tapes of unidirectional continuous fibers, and
depositing the tapes of unidirectional continuous fibers non-continuously on said motor vehicle part in at least one stress concentration zone.

2. The process according to claim 1, wherein the tapes of unidirectional continuous fibers are deposited by orienting the continuous fibers in preferred directions corresponding to main stresses in the at least one stress concentration zone.

3. The process according to claim 1, wherein the tapes of unidirectional continuous fibers are deposited on top of each other.

4. The process according to claim 1, wherein the tapes of unidirectional continuous fibers have a width that is less than 1.3 centimeters.

5. The process according to claim 1, wherein the tapes of unidirectional continuous fibers comprise thermoplastic resin.

6. The process according to claim 1, wherein the tapes of unidirectional continuous fibers, without thermoplastic resin, are deposited at the same time as a heated thermoplastic resin.

7. The process according to claim 5, wherein a thermoplastic resin is used, the thermoplastic resin having a melting point that is substantially identical to a melting point of the thermoplastic material of the motor vehicle part.

8. The process according to claim 5, further comprising, during the depositing the tapes of unidirectional continuous fibers, at least one of:
heating the thermoplastic resin; and
heating said zone of the motor vehicle part.

9. The process according to claim 5, wherein the thermoplastic material is polypropylene-based filled with short glass fibers, and the thermoplastic resin is polypropylene-based.

10. The process according to claim 1, wherein the thermoplastic material is filled with reinforcing fibers and/or talc.

11. The process according to claim 1, wherein the reinforcing unidirectional continuous fibers are selected from glass fiber fibers, carbon fibers and natural fibers.

12. The process according to claim 1, wherein the motor vehicle part is a semi-structural part, including one of an opening and an opening liner.

13. The process according to claim 12, wherein:
the motor vehicle part is an inner liner of a tailgate, and
the at least one stress concentration zone is selected from at least one of an upper region of the tailgate for attaching a hinge, a side region of the tailgate taking up forces of struts, and a lower side region of the tailgate for attaching a lock.

14. The process according to claim 12, wherein the motor vehicle part is a side door or bonnet liner.

15. The process according to claim 1, wherein before molding said motor vehicle part in a mold, the process comprises:
depositing the at least one reinforcing element having the tapes of unidirectional continuous fibers locally on walls of the mold, the tapes of unidirectional continuous fibers being deposited non-continuously on the mold in at least one zone corresponding to a stress concentration zone of the motor vehicle part molded in said mold.

16. The process according to claim 1, wherein before molding said part in a mold, the process comprises:
depositing at least one reinforcing element having the tapes of unidirectional continuous fibers locally on walls of a preform, the tapes being deposited non-continuously on the preform in at least one zone corresponding to a stress concentration zone of the motor vehicle part molded in said mold, and
positioning the preform in the mold.

17. A motor vehicle part, produced by molding filled thermoplastic material and comprising at least one reinforcing element in at least one stress concentration zone, wherein the at least one reinforcing element is a set of discontinuous tapes of unidirectional continuous fibers impregnated with thermoplastic resin, deposited on a surface of said part.

18. The motor vehicle part according to claim 17, wherein the fibers of the discontinuous tapes of unidirectional continuous fibers are oriented in preferred directions corresponding to main stresses in the stress concentration zone.

19. The motor vehicle part according to claim 17, wherein the motor vehicle part is one of an opening or an opening liner.

20. The process according to claim 15, further comprising:
depositing the tapes of unidirectional continuous fibers on the surface of the motor vehicle part.
